(19) United States
(12) Patent Application Publication
(10) Pub. No.: US 2019/0049799 A1
(43) Pub. Date: Feb. 14, 2019

(54) LIQUID CRYSTAL DISPLAY DEVICE

(71) Applicant: Japan Display Inc., Minato-ku (JP)

(72) Inventors: Yasushi IWAKABE, Tokyo (JP); Yuji MAEDE, Tokyo (JP); Jin HIROSAWA, Tokyo (JP)

(73) Assignee: Japan Display Inc., Minato-ku (JP)

(21) Appl. No.: 16/055,722

(22) Filed: Aug. 6, 2018

(30) Foreign Application Priority Data
Aug. 8, 2017 (JP) 2017-153260

(51) Int. Cl. G02F 1/1343; G02F 1/1362; G02F 1/137; G02F 1/1335; G09G 3/36

(52) U.S. Cl. CPC G02F 1/134309; G02F 1/136286; G02F 1/137; G02F 1/133512; G02F 2001/133519; G09G 3/3607; G02F 2001/13706; G02F 2201/121; G02F 2201/123; G02F 1/133514

(57) ABSTRACT

According to one embodiment, a liquid crystal display device comprises first and second substrates and a liquid crystal layer between the substrates. The first substrate includes scanning lines, video lines, a sub-pixel area, a pixel electrode in the sub-pixel area, and a common electrode which generates an electric field between the pixel electrode and the common electrode. The sub-pixel area has a width of 13 μm or less. A gap d between the first substrate and the second substrate is 2.5 μm or less. A liquid crystal material contained in the liquid crystal layer has a refractive anisotropy Δn of 0.1 or more. A product Δnd of the gap d and the refractive anisotropy Δn is 0.20 μm or more and 0.31 μm or less.

### CROSS-REFERENCE TO RELATED APPLICATIONS

This application is based upon and claims the benefit of priority from Japanese Patent Application No. 2017-153260, filed Aug. 8, 2017, the entire contents of which are incorporated herein by reference.

### FIELD

Embodiments described herein relate generally to a liquid crystal display device.

### BACKGROUND

As an example of display devices, a liquid crystal display device employing a lateral electric field mode such as In-plane Switching (IPS) mode is known. The liquid crystal display device of this type comprises a pixel electrode and a common electrode in one of paired substrates facing each other via a liquid crystal layer, and controls the alignment of liquid crystal molecules of the liquid crystal layer by using the lateral electric field generated between the electrodes.

The liquid crystal display device in the lateral electric field mode is employed as a display for, for example, Virtual Reality (VR), Augmented Reality (AR), or Mixed Reality (MR). Recently, display devices including these display devices are required to have high moving image quality. To enhance the moving image quality, a response speed of the liquid crystal layer needs to be made higher.

### BRIEF DESCRIPTION OF THE DRAWINGS

FIG. 1 is an exploded perspective view schematically showing a configuration example of a liquid crystal display device according to one of embodiments.

FIG. 2 is a perspective view schematically showing an example of usage of the liquid crystal display device.

FIG. 3 is a plan view showing a configuration example of a sub-pixel of the liquid crystal display device.

FIG. 4 is a cross-sectional view schematically showing a display panel seen along line IV-IV in FIG. 3.

FIG. 5 is a graph showing a relationship between gap d and refractive anisotropy Δn, and response times tr and tf.

FIG. 6 is a graph showing a relationship between the refractive anisotropy Δn and the response times tr and tf in a case where the gap d is constant.

FIG. 7 is a graph showing a relationship between Δnd and transmissivity.

FIG. 8 is a table showing a relationship between Δnd and hue of the display panel.

FIG. 9 is a cross-sectional view schematically showing a configuration example of a light source.

FIG. 10 is a plan view showing a modified example of a sub-pixel.

FIG. 11 is a plan view showing another modified example of the sub-pixel.

### DETAILED DESCRIPTION

In general, according to one embodiment, a liquid crystal display device comprises a first substrate, a second substrate opposed to the first substrate, and a liquid crystal layer between the first substrate and the second substrate. The first substrate includes scanning lines, video lines, a sub-pixel area surrounded by the scanning lines and the video lines, a pixel electrode in the sub-pixel area, and a common electrode which generates an electric field between the pixel electrode and the common electrode. The sub-pixel area has a width of 13 μm or less. A gap d between the first substrate and the second substrate is 2.5 μm or less. A liquid crystal material contained in the liquid crystal layer has a refractive anisotropy Δn of 0.1 or more. A product Δnd of the gap d and the refractive anisotropy Δn is 0.20 μm or more and 0.31 μm or less.

One of embodiments will be described hereinafter with reference to the accompanying drawings.

The disclosure is merely an example, and proper changes within the spirit of the invention, which are easily conceivable by a skilled person, are included in the scope of the invention as a matter of course. In addition, in some cases, in order to make the description clearer, the drawings may be more schematic than in the actual modes, but they are mere examples, and do not limit the interpretation of the present invention. In the drawings, reference numbers of continuously arranged elements equivalent or similar to each other are omitted in some cases. In addition, in the specification and drawings, structural elements which function in the same or a similar manner to those described in connection with preceding drawings are denoted by like reference numbers, detailed description thereof being omitted unless necessary.

In the present specification, expressions such as “a includes A, B, or C”, “a includes any one of A, B, and C” and “α includes an element selected from a group consisting of A, B, and C” do not exclude a case where a includes combinations of A, B, and C unless otherwise specified. Furthermore, these expressions do not exclude a case where a includes other elements.

In the expression “first α, second α, and third α” in the present specification, “first, second, and third” are convenient numbers used to explain the elements. In other words, an expression “A comprises third α” may indicate a case that A does not comprise first α and second α other than third α, unless otherwise specified.

In the embodiments, a transmissive liquid crystal display device comprising a backlight is disclosed as an example of the display device. The embodiments do not prevent application of individual technical ideas disclosed in the embodiments to the other types of display devices. The other types of display devices are assumed to include, for example, a reflective liquid crystal display device which displays an image using external light, a liquid crystal display device comprising both the transmissive function and the reflective function, and the like.

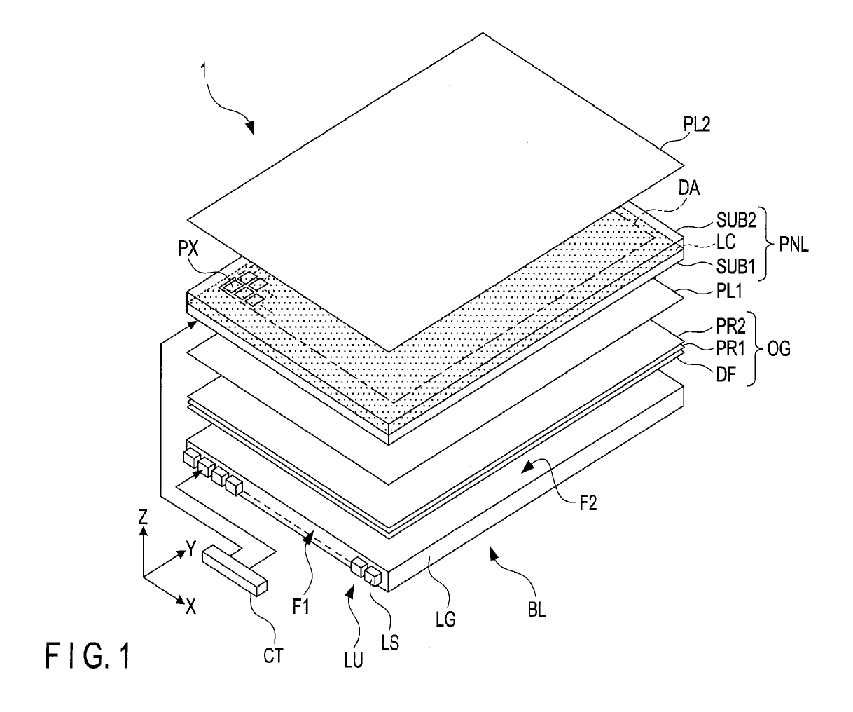

FIG. 1 is an exploded perspective view schematically showing a configuration example of a display device 1. The display device 1 comprises an illumination device BL and a display panel PNL. The first direction X, the second direction Y, and the third direction Z are defined as illustrated. The directions X, Y, and Z are orthogonal to each other but may intersect at an angle other than a right angle. In the present disclosure, a direction indicated by an arrow of the third direction Z is referred to as “above/over”, and an opposite direction of the arrow is referred to as “under/below”.

In the example of FIG. 1, the illumination device BL is a side-edge type backlight which comprises a light guide LG opposed to the display panel PNL and a light source unit LU. However, the structure of the illumination device BL is not limited to the example shown in FIG. 1 but may be a structure configured to supply light necessary for image display. For example, the illumination device BL may be what is called a direct type backlight which comprises a light source disposed under the display panel PNL.

In the example illustrated in FIG. 1, each of the display panel PNL and the light guide LG is formed in a rectangular shape having shorter sides in the first direction X and longer sides in the second direction Y. The shape of each of the display panel PNL and the light guide LG is not limited to a rectangular shape, but may be the other shape.

The light source unit LU comprises light sources LS arranged in the first direction X along incidence surface F1 (side surface) of the light guide LG. The light source LS is, for example, a light-emitting diode but may be a light-emitting element of the other type such as an organic electroluminescent element. The light from the light sources LS is made incident on the light guide LG from the incidence surface F1 and emitted from an emission surface F2 opposed to the display panel PNL.

The display panel PNL is a transmissive liquid crystal panel, and comprises a first substrate SUB1, a second substrate SUB2 opposed to the first substrate SUB1, and a liquid crystal layer LC sealed between the first substrate SUB1 and the second substrate SUB2. The display panel PNL includes a display area DA including pixels PX. The pixels PX are arrayed in a matrix in the first direction X and the second direction Y.

The display device 1 further comprises an optical sheet group OG, a first polarizer PL1, a second polarizer PL2, and a controller CT. The optical sheet group OG includes, for example, a diffusion sheet DF which diffuses the light emitted from the emission surface F2, and a first prism sheet PR1 and a second prism sheet PR2 on which prism lenses are formed. The first polarizer PL1 is disposed between the optical sheet group OG and the first substrate SUB1. The second polarizer PL2 is disposed above the second substrate SUB2.

The controller CT controls the display panel PNL and the light source unit LU. For example, the controller CT can be composed of IC and various circuit elements. The controller CT may be composed of IC which controls the display panel PNL and IC which controls the light source unit LU. In this case, ICs may be disposed at positions remote from each other.

The display device 1 can be used for various devices, for example, a smartphone, a tablet terminal, a mobile telephone, a personal computer, a television receiver, a vehicle-mounted device, a game console, a head-mounted display, and the like.

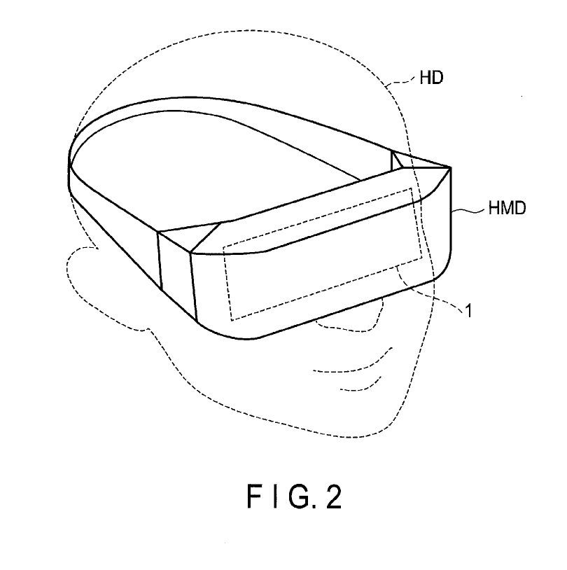

FIG. 2 is a perspective view schematically showing an example of usage of the display device 1. An example of using the display device 1 for the head-mounted display HMD is illustrated. The head-mounted display HMD is mounted on a user's head HD. The user wearing the head-mounted display HMD can see the video displayed on the display screen of the display device 1. This head-mounted display HMD is suitable for usage of VR, AR, or MR. The head-mounted display HMD is supplied with power from the outside via, for example, a cable. However, a battery for power supply may be built in the head-mounted display HMD.

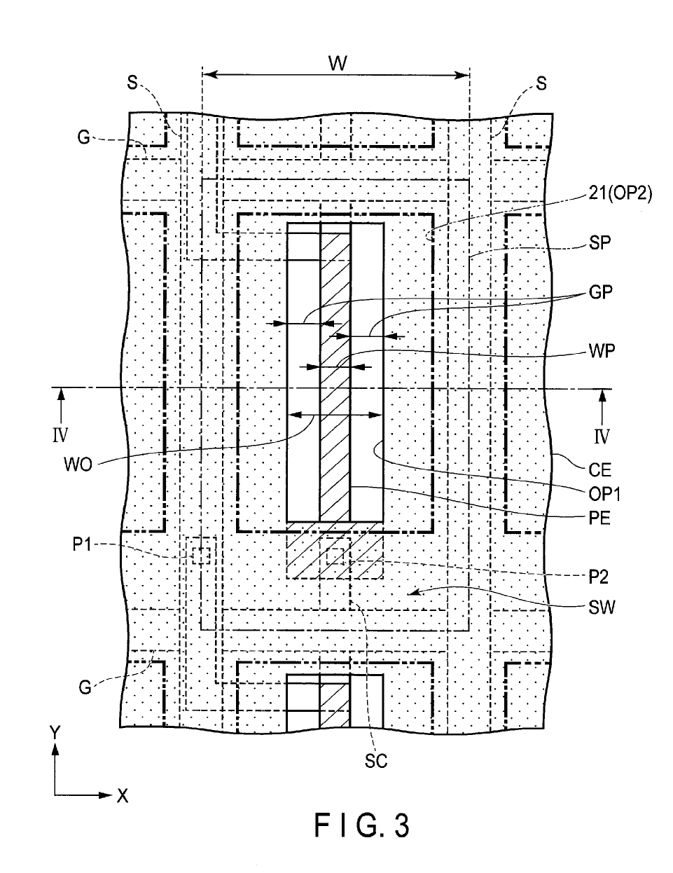

Each of the pixels PX shown in FIG. 1 includes sub-pixels corresponding to different colors. FIG. 3 is a plan view showing a configuration example of a sub-pixel SP.

The display panel PNL includes scanning lines G and video lines S which intersect the scanning lines G. The scanning lines G extend in the first direction X so as to be arranged in the second direction Y. The video lines S extend in the second direction Y so as to be arranged in the first direction X.

An area surrounded by two adjacent scanning lines G and two adjacent video lines S corresponds to one sub-pixel SP (sub-pixel area). A pixel electrode PE and a switching element SW are provided for each sub-pixel SP. The switching element SW includes a semiconductor layer SC. The semiconductor layer SC is connected to the video line S at a first position P1 and is connected to the pixel electrode PE at a second position P2. A double-gate type switching element SW in which the semiconductor layer SC intersects the scanning line G at two times is illustrated in FIG. 3. However, the switching element SW may comprise the other structure such as a single-gate switching element in which the semiconductor layer SC intersects the scanning line G only once.

The common electrode CE is disposed above the pixel electrode PE. The common electrode CE comprises a first opening OP1 in the sub-pixel SP. The pixel electrode PE extends in the first opening OP1.

A light-shielding layer 21 is disposed above the common electrode CE. The light-shielding layer 21 is opposed to the scanning line G, the video line S, and the semiconductor layer SC. The light-shielding layer 21 comprises a second opening OP2 in the sub-pixel SP. The second opening OP2 is an area which contributes to display. The first opening OP1 is located in the second opening OP2 in planar view.

In the example illustrated in FIG. 3, the pixel electrode PE is shaped in a line extending straight in the second direction Y in each of the openings OP1 and OP2. In other words, the pixel electrode PE is not branched in each of the openings OP1 and OP2. Gaps GP exist between the common electrode CE and both sides of the pixel electrode PE in planar view.

Since the user sees the screen in a distance of several centimeters, high definition of the sub-pixels SP is required in the head-mounted display HMD shown in FIG. 2. For example, a width W of the sub-pixel SP is desirably 13 μm (equivalent to the definition of approximately 650 ppi) or less. The width W is more desirably 12 μm (approximately 700 ppi or less and further 10.5 μm (approximately 800 ppi) or less. If the width W is 9.5 μm (approximately 900 ppi or less, the display quality can be extremely higher. For example, the gap GP is smaller than a width WP of the pixel electrode PE. For example, the gap GP is 0.5 μm and the width WP is 2 μm. In this example, a width WO of the first opening OP1 is 3 μm.

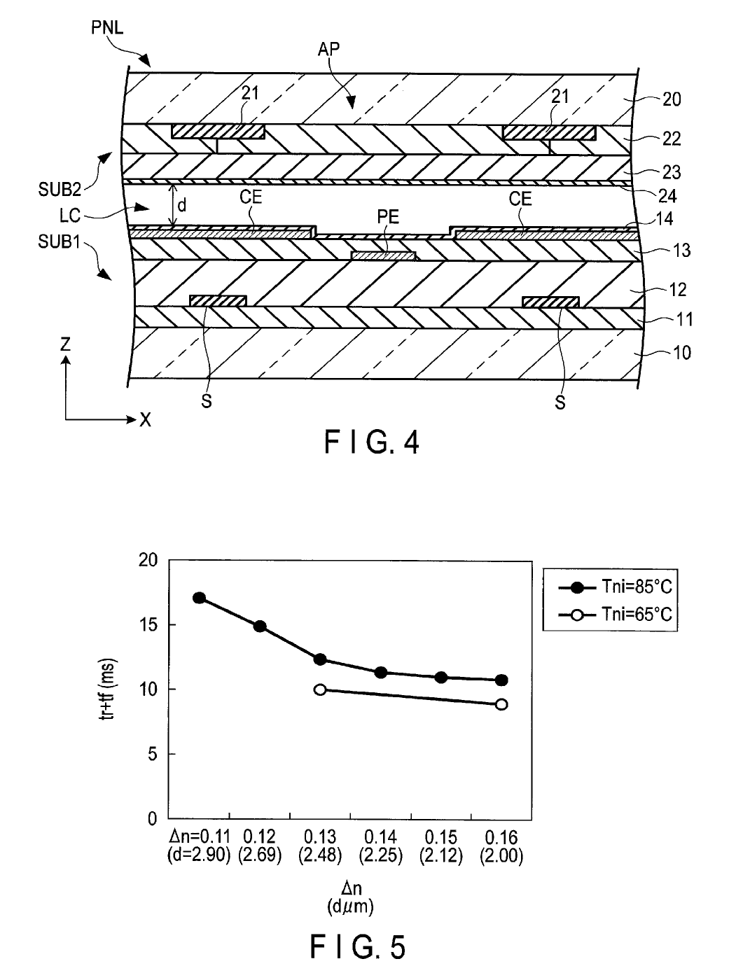

FIG. 4 is a schematically cross-sectional view showing the display panel PNL seen along line IV-IV in FIG. 3. The first substrate SUB1 comprises a first base 10 which is, for example, a glass substrate or a resin substrate, a first insulating layer 11, a second insulating layer 12, a third insulating layer 13, and a first alignment film 14. The first insulating layer 11 covers the first base 10. The video line S is disposed on the first insulating layer 11. The second insulating layer 12 covers the video signal lines S and the first insulating layer 11. The pixel electrode PE is disposed on the second insulating layer 12. The third insulating layer 13 covers the pixel electrode PE and the second insulating layer 12. The common electrodes CE are disposed on the third insulating layer 13. The first alignment film 14 covers the common electrodes CE and the third insulating layer 13.

The second substrate SUB2 comprises a second base 20 which is, for example, a glass substrate or a resin substrate, the light-shielding layer 21, a color filter 22, an overcoat layer 23, and a second alignment film 24. The light-shielding layer 21 is disposed under the second base 20. The color filter 22 covers the second base 20 and the light shielding layer 21. A boundary of adjacent color filters 22 and the light-shielding layer 21 overlap each other. The overcoat layer 23 covers the color filter 22. The second alignment film 24 covers the overcoat layer 23.

A gap d is formed between the first alignment film 14 and the second alignment film 24. The liquid crystal layer LC is disposed between the alignment films 14 and 24. The liquid crystal layer LC is composed of a liquid crystal material (liquid crystal mixture) having refractive anisotropy Δn.

As shown in FIG. 4, the pixel electrode PE and the common electrode CE are disposed on the first substrate SUB1, in the embodiments. More specifically, the common electrode CE is closer to the liquid crystal layer LC than the pixel electrode PE, in the first substrate SUB1. If a voltage is applied to the pixel electrode PE via the video lines S and the switching element SW, a lateral electric field is generated between the pixel electrode PE and the common electrode CE. The liquid crystal molecules of the liquid crystal layer LC rotate by the action of the lateral electric field.

The cross-sectional structure of the display panel PNL is not limited to the example shown in FIG. 4. For example, the pixel electrode PE and the common electrode CE may be disposed in the same layer. In addition, the pixel electrode PE may be disposed in a layer closer to the liquid crystal layer LC than the common electrode CE. In addition, the color filter layer 22 and the light-shielding layer 21 may be disposed in the first substrate SUB1.

If the display device 1 is used for VR, AR, or MR, high moving image quality is required. To enhance the moving image quality, a response speed of the liquid crystal layer LC needs to be made higher. Examples of the liquid crystal material which can be used for the liquid crystal layer LC are a positive liquid crystal material having positive dielectric anisotropy Δε and a negative liquid crystal material having negative dielectric anisotropy Δε. In general, the positive liquid crystal material has a lower rotational viscosity coefficient than the negative liquid crystal material. Therefore, the positive liquid crystal material is more beneficial than the negative liquid crystal material to make the response speed higher. In the embodiments, the liquid crystal layer LC is composed of the positive liquid crystal material.

The response speed can be defined as, for example, a response time tr in which the light transmissivity of the display panel PNL in the initial state reaches a predetermined level when an electric field is applied to the liquid crystal layer LC, and a response time tf in which the transmissivity in the predetermined level lowers to the initial state when application of the electric field to the liquid crystal layer LC is stopped. In general, the response times tr and tf can be represented by the following expressions [1] and [2] using rotational viscosity coefficient γ1 of the liquid crystal material, electric constant ε0, dielectric anisotropy ΔE of the liquid crystal material, force E of the electric field applied to the liquid crystal layer LC, elastic constant K22 of torsional deformation of the liquid crystal material, and the above-mentioned gap d.

tr=γ1/(ε0·Δ·ε·E²−(π²/d²)K22) [1]

tf=(γ1·d²)/(π²·K22) [2]

Thus, the response times tr and tf are inversely proportional to the gap d. Therefore, making the gap d small is most effective for reduction in the response times tr and tf.

In contrast, the transmissivity of the display panel PNL is proportional to product Δnd of the refractive anisotropy Δn of the liquid crystal material and the gap d. More specifically, the transmissivity of the display panel PNL becomes maximum when Δnd is approximately 0.42 μm, and becomes lowered as Δnd is smaller from 0.42 μm. Therefore, if the gap d is made smaller, Δnd is also smaller and the transmissivity of the display panel PNL is also lowered. Furthermore, And also influences the hue of the display panel PNL.

If the gap d is made smaller and Δn is made larger, Δnd can be maintained at a suitable value as a result. However, if Δn is made larger, the molecular weight of the liquid crystal material is increased and γ1 also becomes larger. As evident from the expressions [1] and [2], if γ1 is larger the response times tr and tf are increased.

In a general display panel, and is set to 0.32 to 0.34 μm in consideration of the transmissivity and hue. In this case, for example, Δn is approximately 0.11 and the gap d is 2.9 to 3.1 μm.

As explained below, in the embodiments, the gap d and Δn are optimized from the viewpoint of mainly making the response speed higher.

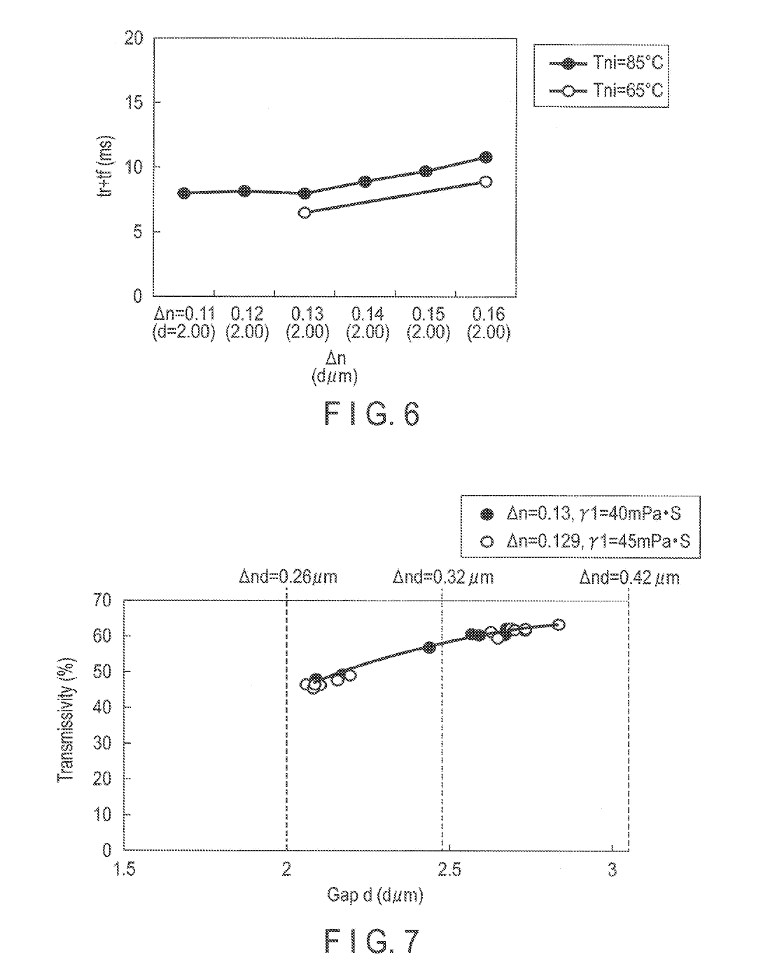

FIG. 5 and FIG. 6 are graphs showing results of simulation of a relationship between Δn and the response times tr and tf, in the display panel PNL having the structure shown in FIG. 3 and FIG. 4. In each of FIG. 5 and FIG. 6, the horizontal axis is Δn and the vertical axis is total response time tr+tf [ms]. In FIG. 5, the gap d [μm] for each Δn was determined to be variable such that Δn was constant at approximately 0.32 μm. The value of the gap d is written under each Δn. In contrast, in FIG. 6, the gap d was constant at 2.00 μm. Furthermore, each simulation was executed when transition temperature Tni of the liquid crystal material was 85° C. and when transition temperature Tni of the liquid crystal material was 65° C.

When attention is focused on the result that Tni was 85° C. in FIG. 5, tr+tf rapidly reduced as Δn increased from 0.11 to 0.13 (i.e., as the gap d reduced from 2.90 μm to 2.48 μm). In contrast, when Δn further increased from 0.13 (i.e., when the gap d further reduced), tr+tf reduced and its slope was gentle. This tendency is based on the relationships represented by the above expressions [1] and [2]. In other words, the response time is reduced as the gap d becomes smaller, but Δn increases, γ1 becomes larger, and the reduction in response time is prevented.

When attention is focused on the result of Tni is 85° C. in FIG. 6, tr+tf was approximately constant until Δn increased to 0.13. When Δn further increased from 0.13, tr+tf increased. This tendency is also based on the relationships represented by the above expressions [1] and [2], similarly to the case shown in FIG. 5.

In both FIG. 5 and FIG. 6, tr+tf was shorter in a case where Tni is 65° C. than in a case where Tni is 85° C. This results from the fact that as the transition temperature is lower the liquid crystal material becomes lower in molecular weight and γ1 is lowered.

It can be understood, based on the graph of FIG. 5, that the response time can be suitably reduced by setting the gap d to 2.50 μm or less. If the gap d is made smaller, the liquid crystal material having Δn of 0.1 or more is desirably used in consideration of the reduction in transmissivity and the variation in hue of the display panel PNL. As shown in FIG. 5 and FIG. 6, however, the improvement of the response time cannot be so expected even if Δn is mad larger than 0.13. Thus, the liquid crystal material having Δn of 0.16 or less, more desirably 0.13 or less is preferably used.

In addition, Δnd is preferably set to 0.32 μm or more from the viewpoint of transmissivity. In the embodiments, however, priority is given to the response speed and Δnd is determined in the range of less than 0.32 μm. As shown in FIG. 6, if Δn is set to 0.13 when the gap d is 2.00 μm, a very preferable response speed at which tr+tf is 10 ms or less can be implemented. In this case, Δnd is 0.26 μm. Even if the gap d is set to 2.5 μm or less as explained above and then Δn is determined such that Δnd is in a range of 0.20 μm or more and 0.31 μm or less, a preferable response speed can be implemented similarly. Setting the gap d and Δn such that Δnd is 0.30 μm or less is more desirable, and setting the gap d and an such that Δnd is 0.28 μm or less is still more desirable for the response time.

Moreover, it can be understood, based on FIG. 5 and FIG. 6, that the response speed is improved as the transition temperature Tni is lower. However, if Tni is too low, the operational environment of the display device 1 may be restricted. Thus, Tni is desirably 50° C. or higher and 90° C. or lower. Tni is more desirably 80° C. or lower and further desirably 70° C. or lower.

As explained above, the rotational viscosity coefficient γ1 of the liquid crystal material increases as Δn is larger. When the relationship between γ1 and Δn in the liquid crystal material having in which Tni is 85° C. was measured, it was recognized that γ1 increased gently until Δn increased to 0.13 and that the slope of the increase became large when Δn exceeded 0.13. For example, γ1 of the liquid crystal material in which Tni is 85° C. and Δn is 0.13 is 60 mPa·s. Thus, use of the liquid crystal material having γ1 of 60 mPa·s or less is desirable. Use of the liquid crystal material having γ1 of 55 mPa·s is more desirable, and use of the liquid crystal material having γ1 of 50 mPa·s is still more desirable. If the liquid crystal material having low γ1 is thus used, the display panel PNL in which tr+tf is 6 ms or less can be implemented.

It Δnd is set to be smaller than that in a general display device, similarly to the embodiments, side effects such as lowering of the transmissivity of the display panel PNL and the shift of hue of the display panel PNL occur. These side effects and their measure will be explained below.

FIG. 7 is a graph showing a result of simulation of the relationship between Δnd and the transmissivity. The transmissivities [%] to plural different gaps d [μm] were obtained in a case where Δn is 0.13 and γ1 is 40 mPa·s and a case where Δn is 0.129 and γ1 is 45 mPa·s. A curve in the graph is an approximated curve of each plot.

In general, the transmissivity of the display panel is maximum when Δnd is approximately 0.42 μm. It is estimated from the approximated curve that the transmissivity is approximately 65% when Δnd is 0.42 μm. In addition, the transmissivity in a case where Δnd is 0.32 μm, which is applied to a general display panel, is approximately 58%. In contrast, the transmissivity in a case where Δnd is 0.26 μm (gap d is 2.0 μm and Δn is 0.13), in the range assumed in the embodiments, is approximately 45% as estimated from the approximated curve. That is, the transmissivity in a case where Δnd is 0.26 μm reduces by approximately 20% as compared with the transmissivity in a case where Δnd is 0.42 μm, and reduces by 10% or more as compared with the transmissivity in a case where Δnd is 0.32 μm.

When the transmissivity is lowered, then the screen luminance is thereby degraded. Degradation of luminance can be corrected by, for example, increasing the quantity of light of the illumination device BL. However, if the quantity of light of the illumination device BL is increased the power consumption is also increased. Then, Δnd is desirably set in a range between 50% or more and 95% or less of Δnd (for example, 0.42 μm) in a case where the transmissivity is maximum. Δnd of 55% or more is more desirable, and Δnd of 60% or more is still more desirable. The concrete value of Δnd can be appropriately determined so as to obtain the desired transmissivity and the desired response speed in consideration of the conditions from the viewpoint of the above-explained response speed.

When the display device 1 is built in the mobile device which operates with a battery, such as a smartphone or a tablet, the duration of the battery is reduced by increasing the quantity of light of the illumination device BL. In contrast, troubles rarely occur at a device which receives power supply from the outside, such as a head-mounted display or a vehicle-mounted device even if the quantity of light of the illumination device BL is increased. When the display device 1 is built in such a device, the display quality can be maintained by increasing the quantity of light of the illumination device BL even if Δnd is made sufficiently low and the transmissivity is lowered.

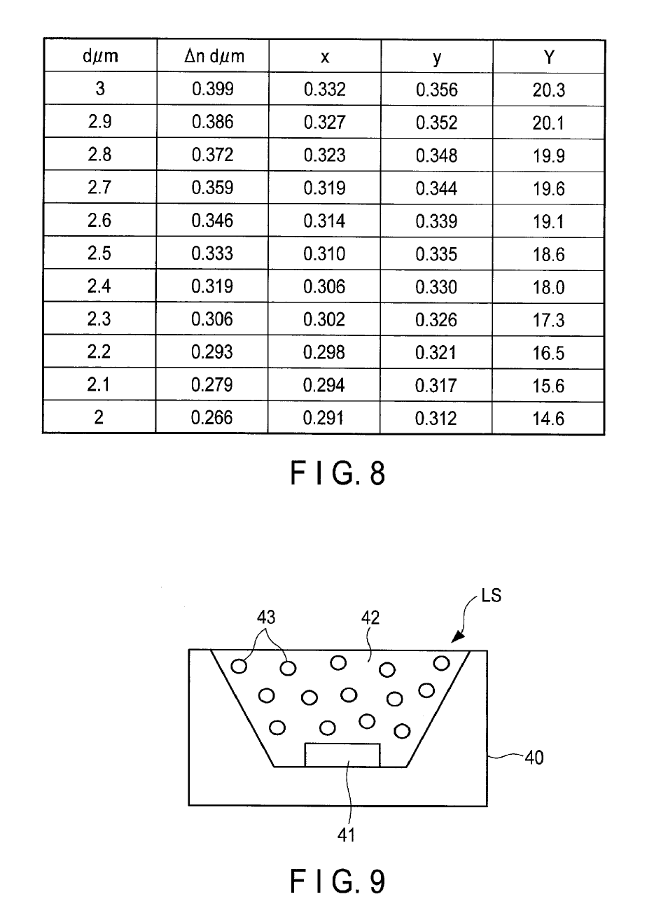

FIG. 8 is a table showing a relationship between Δnd and the hue of the display panel PNL. More specifically, this table shows a result of simulation of the color chromaticities x and y, and luminance Y, in relation to gaps d and Δnd. For example, color chromaticity x is shifted by −0.019 and chromaticity y is shifted by −0.023 in the range assumed in the embodiments in which Δnd is 0.266 μm, as compared with the range employed in a general display panel in which Δnd is 0.333 μm. When Δnd is 0.266 μm, blueness thereby arises on the display panel PNL.

Such a color shift can be corrected by adjusting, for example, the color chromaticities x and y of the light source LS, the area of the sub-pixels SP of each color, the color hue of the color filter 22, hue of each of the alignment films 14 and 24, and the like. For example, when color shift of the first alignment film 14 is corrected, the first alignment film 14 may be colored in yellow by adjusting the quantity of yellow component contained in the first alignment film 14. Thus, the first substrate SUB1 comprising the first alignment film 14 colored in yellow desirably has the transmissivity of the light having a wavelength of 450 nm, of 85% or more and 97% or less. The same correction can also be executed by the second alignment film 24 and the second substrate SUB2.

In addition, above-mentioned color shift can easily be adjusted if what is called YAG-LED is used as the light source LS. FIG. 9 is a cross-sectional view schematically showing a configuration example of the light source LS which is YAG-LED. The light source LS comprises a cup 40. A light-emitting element 41 which emits blue light is disposed on a bottom surface of the cup 40. A resin material 42 containing yellow phosphors 43 disposed inside the cup 40. The yellow phosphors 43 are excited by the light of the light-emitting element 41 to emit yellow light. The blue light emitted from the light-emitting element 41 and the yellow light emitted from the Y phosphors 43 are mixed to generate white light. Since the light source LS uses yellow light for the generation of white light, blueness of the display panel PNL can easily be corrected.

When the display device 1 is used for VR, AR, or MR, a high feeling of immersion can be obtained if the moving image display quality is improved. Improvement of blur edge time (BET) is effective for improvement of the moving image display quality. For example, the blur edge time can be improved by increasing the frame frequency to rewrite the voltage of the pixel electrode PE. For example, the display device 1 desirably has the frame frequency of 80 Hz or more.

In addition, the blur edge time can be more improved by urging the illumination device BL to blink at the moving image display. In blinking, for example, the controller CT controls each light source LS such that the illumination period of the illumination device BL is a predetermined duty ratio (for example, 10%).

In general, a light-emitting diode which emits white light is employed as the light source of the display device. In recent years, a phosphor converting type light emitting diode (Phosphorconverting-white LED) comprising a light-emitting element which emits blue light, a green phosphor which emits green light, and a red phosphor which emits red light has been used for expansion of color gamut. However, since the response performance of the red phosphor used in this type of the light-emitting diode is poor, afterglow of red light may occur when blinking is executed.

In contrast, in YAG-LED mentioned above, the afterglow of red light does not occur since white light can be generated without using reed light. Therefore, YAG-LED is also advantageous when blinking is executed. In addition, if white light is generated by using light-emitting elements of different colors, large space for arranging these light-emitting elements is required in a frame area. In contrast, since the light source LS shown in FIG. 9 comprises only one light-emitting element 41 which emits blue light, the light source LS is designed in a small size and contributes to narrowing the frame area.

In the above-explained embodiments, all of the conditions explained in relation to the gap d, Δn, Δnd, γ1, Tni, and the like do not need to be met simultaneously. Even when at least some of them are met, a suitable action corresponding to the conditions can be obtained.

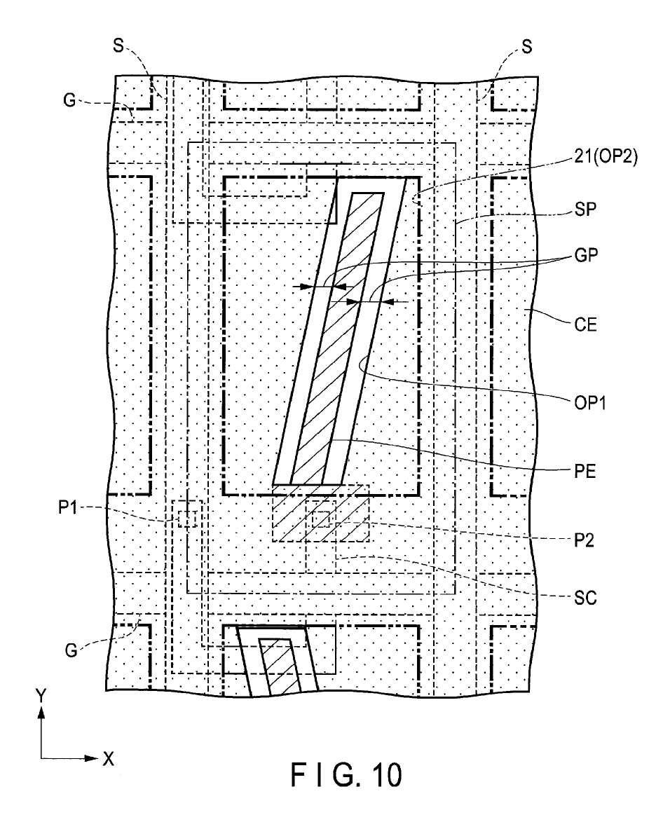

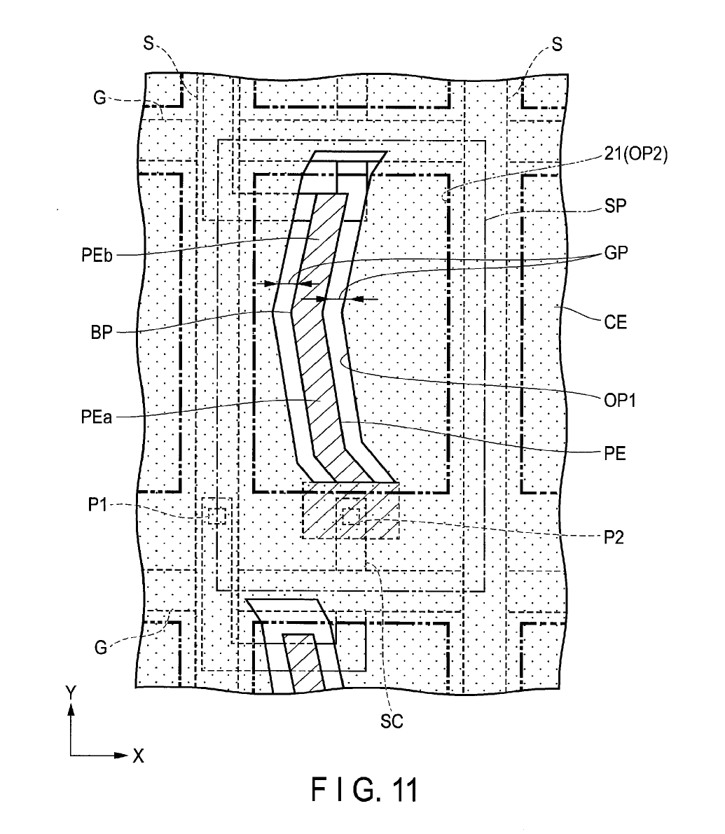

In addition, the structure of the sub-pixel SP shown in FIG. 3 can be variously modified. FIG. 10 and FIG. 11 are plan views showing modified examples of the sub-pixel SP.

In the example shown in FIG. 10, the pixel electrode PE is inclined to the extension direction (second direction Y) of the video line S. The first opening OP1 of the common electrode CE is also inclined to the extension direction of the video line S.

In the example shown in FIG. 10, the pixel electrode PE and the first opening OP1 are inclined rightward to the second direction Y. Oppositely, the pixel electrode PE and the first opening OP1 may be inclined leftward to the second direction Y. In addition, the sub-pixels SP in which the pixel electrode PE and the first opening OP1 are different in direction of inclination may exist together.

In the example of FIG. 11, the pixel electrode PE comprises a first portion PEa, a second portion PEb, and a bending portion BP located between the first portion PEa and the second portion PEb. The first portion PEa is inclined leftward to the second direction Y. The second portion PEb is inclined rightward to the second direction Y. The first opening OP1 is bent similarly to the pixel electrode PE. The first portion PEa may be inclined rightward to the second direction Y and the second portion PEb may be inclined leftward to the second direction Y, oppositely to the example shown in FIG. 11. In addition, these sub-pixels SP may be disposed together.

All of the display devices that can be implemented by a person of ordinary skill in the art through arbitrary design changes to the display devices described above as embodiments of the present invention come within the scope of the present invention as long as they are in keeping with the spirit of the present invention.

Various types of the modified examples are easily conceivable within the category of the ideas of the present invention by a person of ordinary skill in the art and the modified examples are also considered to fall within the scope of the present invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A liquid crystal display device, comprising:
a first substrate;
a second substrate opposed to the first substrate; and
a liquid crystal layer between the first substrate and the second substrate, wherein
the first substrate includes scanning lines, video lines, a sub-pixel area surrounded by the scanning lines and the video lines, a pixel electrode in the sub-pixel area, and a common electrode which generates an electric field between the pixel electrode and the common electrode,
the sub-pixel area has a width of 13 μm or less,
a gap d between the first substrate and the second substrate is 2.5 μm or less,
a liquid crystal material contained in the liquid crystal layer has a refractive anisotropy Δn of 0.1 or more,
a product Δnd of the gap d and the refractive anisotropy Δn is 0.20 μm or more and 0.31 μm or less.

2. The liquid crystal display device of claim 1, wherein
a transition temperature of the liquid crystal material is 50° C. or more and 80° C. or less.

3. The liquid crystal display device of claim 1, wherein
a rotational viscosity coefficient γ1 of the liquid crystal material is 60 mPa·s or less.

4. The liquid crystal display device of claim 1, wherein
the Δnd is 50% or more and 95% or less of Δnd in a case where a transmissivity of the liquid crystal layer is maximum.

5. The liquid crystal display device of claim 1, wherein
the first substrate comprises a first alignment film,
the second substrate comprises a second alignment film opposed to the first alignment film, and
a transmissivity of light having a wavelength of 450 nm of the first substrate or the second substrate is 85% or more and 97% or less.

6. The liquid crystal display device of claim 1, further comprising:
an illumination device which emits light to the first substrate,
wherein
the illumination device comprises a light source which emits white light,
the light source includes a light-emitting element which emits blue light and a phosphor excited by the blue light to emit yellow light, and
the white light is generated by mixing the blue light and the yellow light.

7. The liquid crystal display device of claim 1, further comprising:
an illumination device which emits light to the first substrate,
wherein
the illumination device is urged to blink with a predetermined frequency, in image display.

8. The liquid crystal display device of claim 1, wherein
the liquid crystal material has a positive dielectric anisotropy.

9. The liquid crystal display device of claim 1, wherein
the first substrate or the second substrate comprises a light-shielding layer which overlaps the scanning lines and the video lines,
the light-shielding layer includes an opening in the sub-pixel area, and
the pixel electrode in the opening has a linear shape including no branch portion in planar view.

10. The liquid crystal display device of claim 1, wherein
the refractive anisotropy Δn is 0.16 or less.

11. The liquid crystal display device of claim 1, wherein
the Δnd is 0.30 pin or less.

12. The liquid crystal display device of claim 1, wherein
a width of the sub-pixel area is 10.5 μm or less.

13. The liquid crystal display device of claim 2, wherein
the transition temperature is 50° C. or more and 70° C. or less.

14. The liquid crystal display device of claim 3, wherein
the rotational viscosity coefficient γ1 is 55 mPa·s or less.

15. The liquid crystal display device of claim 9, wherein
the common electrode is located between the pixel electrode and the liquid crystal layer.

16. The liquid crystal display device of claim 15, wherein
the common electrode comprises an opening, and
the pixel electrode extends to the opening.

17. The liquid crystal display device of claim 16, wherein
a gap is formed between both sides of the pixel electrode and the common electrode, in the opening.

18. The liquid crystal display device of claim 17, wherein
the gap is smaller than a width of the pixel electrode.

19. The liquid crystal display device of claim 9, wherein
the pixel electrode is inclined to a direction of extension of the video lines.

20. The display device of claim 9, wherein
the pixel electrode includes a first portion, a second portion, and a bending portion between the first portion and the second portion,
the first portion is inclined to a direction of extension of the video lines, and
the second portion is inclined to the direction of extension of the video lines, at an angle different from the first portion.
